(19) United States
(12) Patent Application Publication
(10) Pub. No.: US 2021/0101800 A1
(43) Pub. Date: Apr. 8, 2021

(54) A LAYERED SILICATE

(71) Applicant: BASF SE, Ludwigshafen am Rhein (DE)

(72) Inventors: Mathias FEYEN, Ludwigshafen (DE); Ulrich MUELLER, Ludwigshafen (DE); Xinhe BAO, Dalian City (CN); Weiping ZHANG, Dalian City (CN); Dirk DE VOS, Leuven (BE); Hermann GIES, Bochum (DE); Feng-Shou XIAO, Hangzhou (CN); Toshiyuki YOKOI, Midori-ku (JP); Ute KOLB, Mainz (DE); Bernd MARLER, Bochum (DE); Yong WANG, Midori-ku (JP); Trees DE BAERDEMAEKER, Leuven (BE); Chuan SHI, Dalian City (CN); Xiulian PAN, Dalian City (CN); Xiangju MENG, Hangzhou (CN); Antje GRUENEWALD-LUEKE, Bochum (DE)

(73) Assignee: BASF SE, Ludwigshafen am Rhein (DE)

(21) Appl. No.: 16/971,875

(22) PCT Filed: Feb. 21, 2019
(86) PCT No.: PCT/CN2019/075675

§ 371 Date: Aug. 21, 2020

(30) Foreign Application Priority Data
Feb. 22, 2018 (CN) PCT/CN2018/076956

(51) Int. Cl. C01B 39/48; B01J 29/70

(52) U.S. Cl. CPC C01B 39/48; B01J 29/70; C01P 2002/72; C01P 2002/77; C01P 2002/86; C01P 2002/88; C01P 2002/82

(57) ABSTRACT

Provided is a crystalline layered silicate, having an X-ray diffraction pattern comprising reflections at 2-theta values of (5.3±0.2)°, (8.6±0.2)°, (9.8±0.2)°, (21.7±0.2)° and (22.7±0.2). Also provided are a process for preparing the crystalline layered silicate and uses of the layered silicate. The process comprises steps of: (i) preparing a synthesis mixture comprising water, a source of Si, and a structure directing agent comprising a diethyldimethylammonium compound; (ii) subjecting the synthesis mixture obtained from (i) to hydrothermal synthesis conditions comprising heating the synthesis mixture obtained from (i) to a temperature in the range of from 110 to 180° C. and keeping the synthesis mixture at a temperature in this range under autogenous pressure for 1 to 6 days, obtaining a mother liquor comprising the crystalline layered silicate.

The present invention relates to a crystalline layered silicate, having an X-ray diffraction pattern comprising reflections at 2-theta values of (5.3±0.2)°, (8.6±0.2)°, (9.8±0.2)°, (21.7±0.2)° and (22.7±0.2)°. Further, the present invention relates to a process for preparing the layered silicate, a tectosilicate prepared therefrom, and a process for preparing a molding, comprising preparing a formable mixture comprising the layered silicate. The present invention further relates to the layered silicate, a tectosilicate prepared therefrom or molding comprising the layered silicate, each being obtainable or obtained by the aforesaid process, and further relates to the use of said layered silicate, tectosilicate therefrom or molding comprising the layered silicate, as a catalytically active material, as a catalyst, or as a catalyst component. Furthermore, the present invention relates to a synthesis mixture, preferably for the synthesis of the layered silicate.

Layered silicates in general are known in the art, such as ITQ-8 presented in Marler, B et al., 2016. In various technical areas, such as, catalysis or adsorption, there is a need for new materials, in particular silicates, and new processes, giving access to tailor-made materials for specific catalytic or adsorption problems, particularly for treating combustion exhaust gas in industrial applications, for example for converting nitrogen oxides (NOₓ) in an exhaust gas stream.

Hydrous Layer Silicates (HLSs) are characterized by a structure consisting of i) pure silica layers (traces of other elements such as Al, B, Ga, Fe), ii) intercalated cations which are of low charge density (organic cations such as tetraethylammonium or [Na(H₂O)₆]⁺ groups). An overview on HLSs is presented in Marler, B et al., 2012. HLSs are sometimes also called “layered zeolites” or “Two-dimensional zeolites”.

Therefore, it is an object of the present invention to provide a new process for the preparation of layered silicates, which may be employed for example in the abovementioned areas as such, or used as precursors for the preparation of tectosilicates. It is also an object of the present invention to provide new layered materials. Furthermore, it is conceivable that the materials obtainable from the new process or the new layered materials may be used as starting materials for the preparation of tectosilicates.

Therefore, the present invention relates to a crystalline layered silicate, having an X-ray diffraction pattern comprising reflections at 2-theta values of (5.3±0.2)°, (8.6±0.2)°, (9.8±0.2)°, (21.7±0.2)°, and (22.7±0.2)°, when measured at a temperature in the range of from 15 to 25° C. with Cu-Kalpha_{1,2} radiation having a wavelength of 0.15419 nm, determined according to X-ray diffraction as described in Reference Example 1.1. Said crystalline layered silicate may also be referred to herein as RUB-56.

Preferably, the layered silicate having an IR spectrum comprising twelve peaks with maxima at (475±5) cm⁻¹, (526±5) cm⁻¹, (587±5) cm⁻¹, (609±5) cm⁻¹, (628±5) cm⁻¹, (698±5) cm⁻¹, (724±5) cm⁻¹, (776±5) cm⁻¹, (587±5) cm⁻¹, (794±5) cm⁻¹, (809±5) cm⁻¹, (837±5) cm⁻¹, determined as described in Reference Example 1.3.

Preferably, the layered silicate having an IR spectrum comprising five peaks with maxima at (1397±5) cm⁻¹, (1421±5) cm⁻¹, (1457±5) cm⁻¹, (1464±5) cm⁻¹, (1487±5) cm⁻¹, determined as described in Reference Example 1.3.

Preferably, the layered silicate having an ²⁹Si MAS NMR spectrum comprising Q³-type signals at (−99±2) ppm and (−101±2) ppm and Q⁴-type signals at (−106±2) ppm and (−108±2) ppm, determined as described in Reference Example 1.4.

In addition to Si, O, C, N and H, the layered silicate may comprise one or more further additional components. Preferably, from 95 to 100 weight-%, more preferably from 98 to 100 weight-%, more preferably from 99 to 100 weight-%, more preferably from 99.5 to 100 weight-%, more preferably from 99.9 to 100 weight-% of the layered silicate consists of Si, O, C, N and H.

Preferably, the layered silicate has a unit cell, determined as described in Reference Example 1.1, according to the following formula (I):

(C₆H₁₆N)₈[Si₃₂O₆₄(OH)₈]*xH₂O (I),

wherein x is in the range of from 8 to 30, preferably in the range of from 16 to 30, more preferably in the range of from 20 to 30, more preferably in the range of from 21 to 28, more preferably in the range of from 22 to 26, more preferably in the range of from 23 to 25. More preferably, x is 24.

It is noted that according to the present invention, the term “crystalline layered silicate” refers to the crystalline layered silicate which comprises the structure directing agent which is used for its preparation.

While there are no specific restrictions, it is preferred that the layered silicate further comprises one or more of Al, B, Ga, Fe, Ti, Sn, In, Ge, Zr, V, and Nb, wherein the one or more of Al, B, Ga, Fe, Ti, Sn, In, Ge, Zr, V, and Nb, calculated as element, are present in a total amount of at most 500 weight-ppm, preferably at most 250 weight-ppm, more preferably at most 100 weight-ppm, based on the total weight of the layered silicate.

Therefore, the present invention relates to a process for preparing a layered silicate, preferably the layered silicate according to the present invention, also referred to herein as RUB-56, comprising:
(i) preparing a synthesis mixture comprising water, a source of Si, and a structure directing agent comprising a diethyldimethylammonium compound;
(ii) subjecting the synthesis mixture obtained from (i) to hydrothermal synthesis conditions comprising heating the synthesis mixture obtained from (i) to a temperature in the range of from 110 to 180° C. and keeping the synthesis mixture at a temperature in this range under autogenous pressure for 1 to 6 days, obtaining a mother liquor comprising the layered silicate.

While there are no specific restrictions, it is preferred that the source of the Si comprises one or more of a wet-process silica, a dry-process silica, and a colloidal silica, more preferably comprising a wet-process silica.

Generally, according to (i), any suitable source of Si can be used. In particular, the source of Si comprises, more preferably is, one or more of a wet-process silica (also known as silica gel), a dry-process silica, and a colloidal silica. Colloidal silica is commercially available, inter alia, for example as Ludox®, Syton®, Nalco® or Snowtex®. “Wet process” silica is commercially available, inter alia, for example as Hi-Sil®, Ultrasil®, Vulcasil®, Santocel®, Valron-Estersil®, Tokusil® or Nipsil®. Furthermore, wet-process silica (also known as silica gel) may be employed, for instance according to Example 1 (i) herein. “Dry process” silica is commercially available, inter alia, for example as Aerosil®, Reolosil®, Cab-O-Sil®, Fransil® or ArcSilica®. More preferably, the source of Si according to (i) comprises, more preferably is, a wet-process silica, more preferably is a silica gel.

Preferably, according to (i) the source of Si comprises, preferably is, a wet process silica, preferably having an X-ray diffraction pattern comprising only one very broad reflection, namely a reflection centered at at a 2-theta values of (23±0.2)°, determined according to X-ray diffraction as described in Reference Example 1.1. The source of Si preferably comprises, preferably is, a wet process silica, preferably having an ²⁹Si MAS NMR spectrum comprising a Q²-type signal at (−92.0±2) ppm, a Q³-type signal at (−102.3±2) ppm, and a Q⁴-type signal at (−110.1±2) ppm.

According to (i), any structure directing agent comprising a diethyldimethylammonium compound may be employed. The structure directing agent preferably comprises a diethyldimethylammonium salt, preferably one or more of a sulfate; a nitrate; a phosphate; an acetate; a halide, more preferably one or more of a chloride and a bromide, more preferably a chloride; and a hydroxide, wherein more preferably, the structure directing agent comprises, more preferably is diethyldimethylammonium hydroxide.

Preferably, in the synthesis mixture obtained from (i) and subjected to (ii), the molar ratio of the structure directing agent relative to the source of Si, calculated as SiO₂, defined as SDA:SiO₂, is in the range of from 0.3:1 to 2:1, more preferably in the range of from 0.4:1 to 1.5:1, more preferably in the range of from 0.5:1 to 1.0:1.

While there are no specific restrictions, it is preferred that in the synthesis mixture obtained from (i) and subjected to (ii), the molar ratio of water relative to the source of Si, calculated as SiO₂, defined as H₂O:SiO₂, is in the range of from 3:1 to 9:1, more preferably in the range of from 4:1 to 8:1, more preferably in the range of from 5:1 to 7:1.

With regard to the synthesis mixture prepared in (i), in addition to water, the source of Si, and the structure directing agent comprising a diethyldimethylammonium compound, the synthesis mixture prepared in (i) may comprise one or more further additional components. Preferably, from 95 to 100 weight-%, more preferably from 98 to 100 weight-%, more preferably from 99 to 100 weight-%, more preferably from 99.5 to 100 weight-%, more preferably from 99.9 to 100 weight-% of the synthesis mixture prepared in (i) consist of water, the source of Si, and the structure directing agent comprising a diethyldimethylammonium compound. The synthesis mixture obtained from (i) which is subjected to (ii) preferably additionally comprises a source of a base, preferably a source of hydroxide. Preferably, the source of hydroxide comprises, preferably is an alkali metal hydroxide, more preferably sodium hydroxide.

With regard to the structure directing agent, it is alternatively preferred that the structure directing agent comprises, preferably is a diethyldimethylammonium halide, more preferably one or more of a chloride or a bromide. Preferably, from 95 to 100 weight-%, more preferably from 98 to 100 weight-%, more preferably from 99 to 100 weight-%, more preferably from 99.5 to 100 weight-%, more preferably from 99.9 to 100 weight-% of the synthesis mixture prepared in (i) consist of the water, the source of Si, the structure directing agent comprising a diethyldimethylammonium compound, and the source of a base.

There are no specific restrictions on how step (i) is carried out. Preferably, preparing the synthesis mixture according to (i) comprises
(i.1) preparing a mixture comprising water, the source of Si, and the structure directing agent comprising a diethyldimethylammonium compound at a temperature of the mixture in the range of from 10 to 40° C.;
(i.2) heating the mixture prepared in (i.1) to a temperature in the range of from 50 to 120° C. and keeping the mixture at a temperature in this range obtaining the synthesis mixture.

According to (i.1), the mixture is preferably prepared at a temperature of the mixture in the range of from 20 to 30° C. Preferably, preparing the mixture according to (i.1) comprises stirring the mixture.

According to (i.2), the mixture is preferably heated to a temperature in the range of from 50 to 100° C., more preferably in the range of from 55 to 90° C., more preferably in the range of from 60 to 80° C. Preferably, according to (i.2), the mixture is kept at the temperature for a time of at least 45 min, more preferably for a time in the range of from 50 to 160 min, more preferably in the range of from 55 to 120 min, more preferably in the range of from 60 to 90 min. Preferably, according to (i.2), the mixture is kept at the temperature at an absolute pressure of less than 1 bar, more preferably of at most 500 mbar, more preferably of at most 100 mbar, more preferably of at most 50 mbar. Preferably, according to (i.2), the mixture is kept at the temperature at an absolute pressure in the range of from 5 to 50 mbar, more preferably in the range of from 10 to 40 mbar, more preferably in the range of from 15 to 30 mbar, preferably in a vacuum oven.

With regard to the mixture obtained from (i.1) and subjected to (i.2), the molar ratio of water relative to the source of Si, calculated as SiO₂, defined as the H₂O:SiO₂, is preferably in the range of from 4:1 to 15:1, more preferably in the range of from 5:1 to 11:1, more preferably in the range of from 6:1 to 8:1.

As to step (ii), the heating according to (ii) is preferably carried out in an autoclave. Preferably, keeping the synthesis mixture at the temperature according to (ii) is carried out in an autoclave, preferably the autoclave as defined herein.

The heating according to (ii) is preferably carried out at a heating rate in the range of from 0.5 to 4 K/min, preferably in the range of from 1 to 3 K/min. Preferably, according to (ii), the synthesis mixture is heated to a temperature in the range of from 120 to 170° C., more preferably in the range of from 130 to 160° C., more preferably in the range of from 135 to 145° C. Preferably, the hydrothermal synthesis conditions according to (ii) comprise a hydrothermal synthesis time in the range of from 24 to 120 h, more preferably in the range of from 24 to 96 h, more preferably in the range of from 24 to 72 h. The hydrothermal synthesis conditions according to (ii) preferably comprises agitating, preferably mechanically agitating, more preferably stirring the synthesis mixture.

In the context of the present invention, the process preferably further comprises
(iii) cooling the mother liquor obtained from (ii), preferably to a temperature of the mother liquor in the range of from 10 to 50° C., more preferably in the range of from 20 to 35° C.

Since, as mentioned above, a mother liquor is obtained from (ii) comprising the layered silicate, it is further preferred that the inventive process further comprises
(iv) separating the layered silicate from the mother liquor obtained from (ii) or (iii), preferably from (iii).

There are no specific restrictions on how the layered silicate is separated. Preferably, said separation step (iv) comprises
(iv.1) subjecting the mother liquor obtained from (ii) or (iii), preferably from (iii), to a solid-liquid separation method, preferably comprising centrifugation, filtration, or rapid-drying, preferably spray-drying, more preferably comprising centrifugation;
(iv.2) preferably washing the layered silicate separated from the mother liquor according to (iv.1);
(iv.3) drying the layered silicate obtained from (iv.1) or (iv.2), preferably (iv.2).

If (iv.2) is carried out, it is preferred that the layered silicate is washed with water, preferably distilled water, preferably until the washing water has a conductivity of at most 500 microSiemens, preferably at most 200 microSiemens. As to (iv.3), it is preferred that the layered silicate is dried in a gas atmosphere having a temperature in the range of from 10 to 50° C., more preferably in the range of 25 to 30° C. Preferably, the gas atmosphere comprises oxygen, more preferably is air, lean air, or synthetic air.

Furthermore, the present invention relates to a process for preparing a tectosilicate, comprising preparing a layered silicate by a process as described herein above, preferably according to the process described herein above comprising separating the layered silicate from the mother liquor, the process further comprising
(v) calcining the layered silicate, preferably obtained from (iv).

The present invention yet further relates to a process for preparing a tectosilicate, comprising
(v) calcining a layered silicate, obtainable or obtained by the process as described herein above, preferably by the process described herein above comprising separating the layered silicate from the mother liquor.

According to (v), the layered silicate is preferably calcined in a gas atmosphere having a temperature in the range of from 300 to 700° C., more preferably in the range of from 300 to 600° C., more preferably in the range of from 400 to 600° C., more preferably in the range of from 450 to 550° C. Preferably, the gas atmosphere comprises oxygen, more preferably is air, lean air, or synthetic air.

The present invention yet further relates to a process for preparing a molding, comprising preparing a formable mixture comprising the layered silicate as described herein above or a layered silicate obtainable or obtained by a process as described herein above and further optionally comprising one or more of a source of a binder material, a plasticizing agent, and a pore forming agent; subjecting the formable mixture to shaping obtaining a molding; and optionally post-treating the molding comprising one or more of washing, drying, and calcination.

Depending on the intended use of the layered silicate of the present invention, preferably obtained from (ii) of the inventive process can be employed as such. Further, it is conceivable that the layered silicate is subjected to one or more further post-treatment steps. For example, the layered silicate which is most preferably obtained as a powder can be suitably processed to a moulding or a shaped body by any suitable method, including, but no restricted to, extruding, tabletting, spraying and the like. Preferably, the shaped body may have a rectangular, a triangular, a hexagonal, a square, an oval or a circular cross section, and/or preferably is in the form of a star, a tablet, a sphere, a cylinder, a strand, or a hollow cylinder. When preparing a shaped body, one or more binders can be used which may be chosen according to the intended use of the shaped body. Possible binder materials include, but are not restricted to, graphite, silica, titania, zirconia, alumina, and a mixed oxide of two or more of silicon, titanium and zirconium. The weight ratio of the layered silicate relative to the binder is generally not subject to any specific restrictions and may be, for example, in the range of from 10:1 to 1:10. According to a further example according to which the layered silicate is used, for example, as a catalyst or as a catalyst component for treating an exhaust gas stream, for example an exhaust gas stream of an engine, it is possible that the layered silicate is used as a component of a washcoat to be applied onto a suitable substrate, such as a wall-flow filter or the like.

The present invention further relates to a layered silicate, preferably the layered silicate as described herein above, obtainable or obtained by a process as described herein above

The present invention yet further relates to a tectosilicate, obtainable or obtained by a process as described herein above comprising calcining the layered silicate.

The present invention further relates to a molding, obtainable or obtained by a process as described herein above.

The layered silicate, tectosilicate and molding of the present invention can be used for any conceivable purpose, including, but not limited to, an absorbent, a molecular sieve, a catalyst, a catalyst carrier or an intermediate for preparing one or more thereof. Preferably, the layered silicate of the present invention is used as a catalytically active material, as a catalyst, as an intermediate for preparing a catalyst, or as a catalyst component. Preferably, the tectosilicate of the present invention is used as a catalytically active material, as a catalyst, as an intermediate for preparing a catalyst, or as a catalyst component. Preferably, the molding of the present invention is used as a catalytically active material, as a catalyst, as an intermediate for preparing a catalyst, or as a catalyst component.

The present invention yet further relates to a synthesis mixture, preferably for the synthesis of a layered silicate, more preferably for the synthesis of a layered silicate as described herein above, said synthesis mixture comprising water, a source of Si, and a structure directing agent comprising a diethyldimethylammonium compound, wherein in the synthesis mixture, the molar ratio of water relative to the source of silica, calculated as SiO₂, defined as H₂O:SiO₂, is in the range of from 3:1 to 9:1, preferably in the range of from 4:1 to 8:1, more preferably in the range of from 5:1 to 7:1 and the molar ratio of the structure directing agent relative to the source of Si, calculated as SiO₂, defined as SDA:SiO₂, is in the range of from 0.3:1 to 2:1, preferably in the range of from 0.4:1 to 1.5:1, more preferably in the range of from 0.5:1 to 1.0:1, wherein the source of the Si comprises one or more of a wet-process silica, a dry-process silica, and a colloidal silica, wherein the structure directing agent comprises a diethyldimethylammonium salt, preferably one or more of a sulfate; a nitrate; a phosphate; an acetate, one or more of a halide, preferably one or more of a chloride and a bromide, more preferably a chloride; and a hydroxide; wherein more preferably, the structure directing agent comprises, more preferably is diethyldimethylammonium hydroxide, wherein at from 95 to 100 weight-%, preferably from 98 to 100 weight-%, more preferably from 99 to 100 weight-%, more preferably from 99.5 to 100 weight-%, more preferably from 99.9 to 100 weight-% of the synthesis mixture consist of water, the source of Si, and the structure directing agent.

The present invention is further illustrated by the following set of embodiments and combinations of embodiments resulting from the dependencies and back-references as indicated. In particular, it is noted that in each instance where a range of embodiments is mentioned, for example in the context of a term such as “The crystalline layered silicate of any one of embodiments 1 to 4”, every embodiment in this range is meant to be explicitly disclosed for the skilled person, i.e. the wording of this term is to be understood by the skilled person as being synonymous to “The layered silicate of any one of embodiments 1, 2, 3, and 4”.
1. A crystalline layered silicate, having an X-ray diffraction pattern comprising reflections at 2-theta values of (5.3±0.2)°, (8.6±0.2)⁰, (9.8±0.2)⁰, (21.7±0.2)⁰, (22.7±0.2)⁰, when measured at a temperature in the range of from 15 to 25° C. with Cu-Kalpha_{1,2} radiation having a wavelength of 0.15419 nm, determined according to X-ray diffraction as described in Reference Example 1.1.
2. The crystalline layered silicate of embodiment 1, having an IR spectrum comprising twelve peaks with maxima at (475±5) cm⁻¹, (526±5) cm⁻¹, (587±5) cm⁻¹, (609±5) cm⁻¹, (628±5) cm⁻¹, (698±5) cm⁻¹, (724±5) cm⁻¹, (776±5) cm⁻¹, (587±5) cm⁻¹, (794±5) cm⁻¹, (809±5) cm⁻¹, (837±5) cm⁻¹, determined as described in Reference Example 1.3.
3. The crystalline layered silicate of embodiment 2, having an IR spectrum additionally comprising five peaks with maxima at (1397±5) cm⁻¹, (1421±5) cm⁻¹, (1457±5) cm⁻¹, (1464±5) cm⁻¹, (1487±5) cm⁻¹, determined as described in Reference Example 1.3.
4. The crystalline layered silicate of any one of embodiments 1 to 3, having an ²⁹Si MAS NMR spectrum comprising Q³-type signals at (−99±2) ppm and (−101±2) ppm and Q⁴-type signals at (−106±2) ppm and (−108±2) ppm, determined as described in Reference Example 1.4.
5. The crystalline layered silicate of any one of embodiments 1 to 4, wherein from 95 to 100 weight-%, preferably from 98 to 100 weight-%, more preferably from 99 to 100 weight-%, more preferably from 99.5 to 100 weight-%, more preferably from 99.9 to 100 weight-% of the layered silicate consists of Si, O, C, N and H.
6. The crystalline layered silicate of any one of embodiments 1 to 5, having a unit cell, determined as described in Reference Example 1.1, according to the following formula (I):

(C₆H₁₆N)₈[Si₃₂O₆₄(OH)₈]*xH₂O (I),

wherein x is in the range of from 8 to 30, preferably in the range of from 16 to 30, wherein more preferably, x is 24.
7. The crystalline layered silicate of any one of embodiments 1 to 6, further comprising one or more of Al, B, Ga, Fe, Ti, Sn, In, Ge, Zr, V, and Nb, wherein the one or more of Al, B, Ga, Fe, Ti, Sn, In, Ge, Zr, V, and Nb, calculated as element, are present in a total amount of at most 500 weight-ppm, preferably at most 250 weight-ppm, more preferably at most 100 weight-ppm, based on the total weight of the layered silicate.
8. A process for preparing a crystalline layered silicate, preferably the crystalline layered silicate according to any one of embodiments 1 to 7, comprising:
   (i) preparing a synthesis mixture comprising water, a source of Si, and a structure directing agent comprising a diethyldimethylammonium compound;
   (ii) subjecting the synthesis mixture obtained from (i) to hydrothermal synthesis conditions comprising heating the synthesis mixture obtained from (i) to a temperature in the range of from 110 to 180° C. and keeping the synthesis mixture at a temperature in this range under autogenous pressure for 1 to 6 days, obtaining a mother liquor comprising the crystalline layered silicate.
9. The process of embodiment 8, wherein the source of the Si comprises one or more of a wet-process silica, a dry-process silica, and a colloidal silica, preferably comprises a wet-process silica.
10. The process of embodiment 8 or 9, wherein the source of the Si comprises, preferably consists of a wet process silica, and wherein said wet process silica is obtainable or obtained by a method comprising:
   (1) providing a solution comprising a silicate, preferably a tetraalkyl silicate, more preferably a tetraalkyl orthosilicate, more preferably tetraethyl orthosilicate, and an alcohol, preferably ethanol;
   (2) providing an aqueous solution comprising NH₄F;
   (3) mixing the solution prepared in (1) and the solution prepared in (2), heating the obtained mixture to a temperature of the mixture the range of from 50 to 80° C. and keeping the mixture at this temperature for a period of time, preferably in the range of from 1 to 5 d, more preferably in the range of from 2 to 4 d, further heating said mixture to a temperature of the mixture in the range of from 100 to 120° C. and keeping the mixture at this temperature for a period of time, preferably in the range of from 0.2 to 3 d, more preferably in the range of from 0.5 to 2 d, further heating said mixture to a temperature in the range of from 450 to 550° C. and keeping the mixture at this temperature for a period of time, preferably in the range of from 2 to 8 d, more preferably in the range of from 4 to 6 d, obtaining a wet-process silica;
   (4) optionally milling the wet-process silica obtained from (3);
   or
   wherein the process further comprises preparing said wet process silica by a method comprising
   (1) providing a solution comprising a silicate, preferably a tetraalkyl silicate, more preferably a tetraalkyl orthosilicate, more preferably tetraethyl orthosilicate, and an alcohol, preferably ethanol;
   (2) providing an aqueous solution comprising NH₄F;
   (3) mixing the solution prepared in (1) and the solution prepared in (2), heating the obtained mixture to a temperature of the mixture the range of from 50 to 80° C. and keeping the mixture at this temperature for a period of time, preferably in the range of from 1 to 5 d, more preferably in the range of from 2 to 4 d, further heating said mixture to a temperature of the mixture in the range of from 100 to 120° C. and keeping the mixture at this temperature for a period of time, preferably in the range of from 0.2 to 3 d, more preferably in the range of from 0.5 to 2 d, further heating said mixture to a temperature in the range of from 450 to 550° C. and keeping the mixture at this temperature for a period of time, preferably in the range of from 2 to 8 d, more preferably in the range of from 4 to 6 d, obtaining a wet-process silica;
   (4) optionally milling the wet-process silica obtained from (3).
11. The process of embodiment 8 or 9, wherein the wet process silica exhibits one or more of the following characteristics:
   an X-ray diffraction pattern comprising reflections at 2-theta values of (23±0.2)°, determined according to X-ray diffraction as described in Reference Example 1.1;
   a ²⁹Si MAS NMR spectrum comprising a Q²-type signal at (−92.0±2) ppm, a Q³-type signal at (−102.3±2) ppm, and a Q⁴-type signal at (−110.1±2) ppm.
12. The process of any one of embodiments 8 to 11, wherein the structure directing agent comprises a diethyldimethylammonium salt, preferably one or more of a sulfate; a nitrate; a phosphate; an acetate; a halide, preferably one or more of a chloride and a bromide, more preferably a chloride; and a hydroxide, wherein more preferably, the structure directing agent comprises, more preferably is diethyldimethylammonium hydroxide.
13. The process of any one of embodiments 8 to 12, wherein in the synthesis mixture obtained from (i) and subjected to (ii), the molar ratio of the structure directing agent relative to the source of Si, calculated as SiO₂, defined as SDA:SiO₂, is in the range of from 0.3:1 to 2:1, preferably in the range of from 0.4:1 to 1.5:1, more preferably in the range of from 0.5:1 to 1.0:1.
14. The process of any one of embodiments 8 to 13, wherein in the synthesis mixture obtained from (i) and subjected to (ii), the molar ratio of water relative to the source of Si, calculated as SiO₂, defined as H₂O:SiO₂, is in the range of from 3:1 to 9:1, preferably in the range of from 4:1 to 8:1, more preferably in the range of from 5:1 to 7:1.
15. The process of any one of embodiments 8 to 14, wherein from 95 to 100 weight-%, preferably from 98 to 100 weight-%, more preferably from 99 to 100 weight-%, more preferably from 99.5 to 100 weight-%, more preferably from 99.9 to 100 weight-% of the synthesis mixture prepared in (i) consist of water, the source of Si, and the structure directing agent comprising a diethyldimethylammonium compound.
16. The process of any one of embodiments 8 to 15, wherein the synthesis mixture obtained from (i) which is subjected to (ii) additionally comprises a source of a base, preferably a source of hydroxide.
17. The process of embodiment 16, wherein the source of hydroxide comprises, preferably is an alkali metal hydroxide, preferably sodium hydroxide.
18. The process of embodiment 16 or 17, wherein the structure directing agent comprises, preferably is a diethyldimethylammonium halide, preferably one or more of a chloride or a bromide.
19. The process of any one of embodiments 16 to 18, wherein from 95 to 100 weight-%, preferably from 98 to 100 weight-%, more preferably from 99 to 100 weight-%, more preferably from 99.5 to 100 weight-%, more preferably from 99.9 to 100 weight-% of the synthesis mixture prepared in (i) consist of the water, the source of Si, the structure directing agent comprising a diethyldimethylammonium compound, and the source of a base.
20. The process of any one of embodiments 8 to 19, wherein preparing the synthesis mixture according to (i) comprises
   (i.1) preparing a mixture comprising water, the source of Si, and the structure directing agent comprising a diethyldimethylammonium compound at a temperature of the mixture in the range of from 10 to 40° C.;
   (i.2) heating the mixture prepared in (i.1) to a temperature in the range of from 50 to 120° C. and keeping the mixture at a temperature in this range obtaining the synthesis mixture.
21. The process of embodiment 20, wherein according to (i.1), the mixture is prepared at a temperature of the mixture in the range of from 20 to 30° C.
22. The process of embodiment 20 or 21, wherein preparing the mixture according to (i.1) comprises stirring the mixture.
23. The process of any one of embodiments 20 to 22, wherein according to (i.2), the mixture is heated to a temperature in the range of from 50 to 100° C., preferably in the range of from 55 to 90° C., more preferably in the range of from 60 to 80° C.
24. The process of any one of embodiments 20 to 23, wherein according to (i.2), the mixture is kept at the temperature for a time of at least 45 min, preferably for a time in the range of from 50 to 160 min, more preferably in the range of from 55 to 120 min, more preferably in the range of from 60 to 90 min.
25. The process of any one of embodiments 20 to 24, wherein according to (i.2), the mixture is kept at the temperature at an absolute pressure of less than 1 bar, preferably of at most 500 mbar, more preferably of at most 100 mbar, more preferably of at most 50 mbar.
26. The process of any one of embodiments 20 to 25, wherein according to (i.2), the mixture is kept at the temperature at an absolute pressure in the range of from 5 to 50 mbar, more preferably in the range of from 10 to 40 mbar, more preferably in the range of from 15 to 30 mbar, preferably in a vacuum oven.
27. The process of any one of embodiments 20 to 26, wherein in the mixture obtained from (i.1) and subjected to (i.2), the molar ratio of water relative to the source of Si, calculated as SiO₂, defined as the H₂O:SiO₂, is in the range of from 4:1 to 15:1, preferably in the range of from 5:1 to 11:1, more preferably in the range of from 6:1 to 8:1.
28. The process of any one of embodiments 8 to 27, wherein heating according to (ii) is carried out in an autoclave.
29. The process of any one of embodiments 8 to 27, wherein keeping the synthesis mixture at the temperature according to (ii) is carried out in an autoclave, preferably the autoclave as defined in embodiment 28.
30. The process of any one of embodiments 8 to 29, wherein heating according to (ii) is carried out at a heating rate in the range of from 0.5 to 4 K/min, preferably in the range of from 1 to 3 K/min.
31. The process of any one of embodiments 8 to 30, wherein according to (ii), the synthesis mixture is heated to a temperature in the range of from 120 to 170° C., preferably in the range of from 130 to 160° C., more preferably in the range of from 135 to 145° C.
32. The process of any one of embodiments 8 to 31, wherein the hydrothermal synthesis conditions according to (ii) comprise a hydrothermal synthesis time in the range of from 24 to 120 h, preferably in the range of from 24 to 96 h, more preferably in the range of from 24 to 72 h.
33. The process of any one of embodiments 8 to 32, wherein the hydrothermal synthesis conditions according to (ii) comprises agitating, preferably mechanically agitating, more preferably stirring the synthesis mixture.
34. The process of any one of embodiments 8 to 33, further comprising
   (iii) cooling the mother liquor obtained from (ii), preferably to a temperature of the mother liquor in the range of from 10 to 50° C., more preferably in the range of from 20 to 35° C.
35. The process of any one of embodiments 8 to 34, further comprising
   (iv) separating the crystalline layered silicate from the mother liquor obtained from (ii) or (iii), preferably from (iii).
36. The process of embodiment 35, wherein (iv) comprises
   (iv.1) subjecting the mother liquor obtained from (ii) or (iii), preferably from (iii), to a solid-liquid separation method, preferably comprising centrifugation, filtration, or rapid-drying, preferably spray-drying, more preferably comprising centrifugation;
   (iv.2) preferably washing the crystalline layered silicate separated from the mother liquor according to (iv.1);
   (iv.3) drying the crystalline layered silicate obtained from (iv.1) or (iv.2), preferably (iv.2).
37. The process of embodiment 36, wherein according to (iv.2), the crystalline layered silicate is washed with water, preferably distilled water, preferably until the washing water has a conductivity of at most 500 microSiemens, preferably at most 200 microSiemens.
38. The process of embodiment 36 or 37, wherein according to (iv.3), the crystalline layered silicate is dried in a gas atmosphere having a temperature in the range of from 10 to 50° C., preferably in the range of 25 to 30° C.
39. The process of embodiment 38, wherein the gas atmosphere comprises oxygen, preferably is air, lean air, or synthetic air.
40. A process for preparing a tectosilicate, comprising preparing a crystalline layered silicate by a process according to any one of embodiments 8 to 39, preferably according to any one of embodiments 35 to 39, the process further comprising
   (v) calcining the crystalline layered silicate, preferably obtained from (iv).
41. A process for preparing a tectosilicate, comprising
   (v) calcining a crystalline layered silicate, obtainable or obtained by a process according to any one of embodiments 8 to 39, preferably according to any one of embodiments 35 to 39.
42. The process of embodiment 40 or 41, wherein according to (v), the crystalline layered silicate is calcined in a gas atmosphere having a temperature in the range of from 300 to 700° C., preferably in the range of from 300 to 600° C., more preferably in the range of from 400 to 600° C., more preferably in the range of from 450 to 550° C.
43. The process of embodiment 42, wherein the gas atmosphere comprises oxygen, preferably is air, lean air, or synthetic air.
44. A process for preparing a molding, comprising preparing a formable mixture comprising a crystalline layered silicate according to any one of embodiments 1 to 7 or a crystalline layered silicate obtainable or obtained by a process according to any one of embodiments 8 to 39 and further optionally comprising one or more of a source of a binder material, a plasticizing agent, and a pore forming agent; subjecting the formable mixture to shaping obtaining a molding; and optionally post-treating the molding comprising one or more of washing, drying, and calcination.
45. A crystalline layered silicate, preferably the crystalline layered silicate according to any one of embodiments 1 to 7, obtainable or obtained by a process according to any one of embodiments 8 to 39.
46. A tectosilicate, obtainable or obtained by a process according to any one of embodiments 40 to 43.
47. A molding, obtainable or obtained by a process according to embodiment 44.
48. Use of a crystalline layered silicate according to any one of embodiments 1 to 7 or 45 as a catalytically active material, as a catalyst, as an intermediate for preparing a catalyst, or as a catalyst component.
49. Use of a tectosilicate according to embodiment 46 as a catalytically active material, as a catalyst, as an intermediate for preparing a catalyst, or as a catalyst component.
50. Use of a molding according to embodiment 47 as a catalytically active material, as a catalyst, as an intermediate for preparing a catalyst, or as a catalyst component.
51. A synthesis mixture, preferably for the synthesis of a crystalline layered silicate, more preferably for the synthesis of a crystalline layered silicate according to any one of embodiments 1 to 7, said synthesis mixture comprising water, a source of Si, and a structure directing agent comprising a diethyldimethylammonium compound;
   wherein in the synthesis mixture, the molar ratio of water relative to the source of silica, calculated as SiO₂, defined as H₂O:SiO₂, is in the range of from 3:1 to 9:1, preferably in the range of from 4:1 to 8:1, more preferably in the range of from 5:1 to 7:1 and the molar ratio of the structure directing agent relative to the source of Si, calculated as SiO₂, defined as SDA:SiO₂, is in the range of from 0.3:1 to 2:1, preferably in the range of from 0.4:1 to 1.5:1, more preferably in the range of from 0.5:1 to 1.0:1;
   wherein the source of the Si comprises one or more of a wet-process silica, a dry-process silica, and a colloidal silica;
   wherein the structure directing agent comprises a diethyldimethylammonium salt, preferably one or more of a sulfate; a nitrate; a phosphate; an acetate, one or more of a halide, preferably one or more of a chloride and a bromide, more preferably a chloride; and a hydroxide; wherein more preferably, the structure directing agent comprises, more preferably is diethyldimethylammonium hydroxide;
   wherein at from 95 to 100 weight-%, preferably from 98 to 100 weight-%, more preferably from 99 to 100 weight-%, more preferably from 99.5 to 100 weight-%, more preferably from 99.9 to 100 weight-% of the synthesis mixture consist of water, the source of Si, and the structure directing agent.

The present invention is further illustrated by the following examples, comparative examples, and reference examples.

### EXAMPLES

### Reference Example 1.1: Determination of the XRD Patterns

The XRD diffraction patterns were determined using a Siemens D5000 powder diffractometer using Cu Kalpha1 radiation (lambda=1.54059 Angstrom). Borosilicate glass capillaries (diameter: 0.3 mm) were used as a sample holder. The diffractometer was equipped with a germanium (111) primary monochromator and a Braun linear position-sensitive detector (2Theta coverage=6°). For Example 1, the structure was solved by comparison with the XRD powder data of ITQ-8 and by comparison with the FTIR spectrum of ITQ-8. The structure of RUB-56 was refined using the FullProf 2K program.

### Reference Example 1.2: Scanning Electron Microscopy

The SEM (Scanning Electron Microscopy) pictures (secondary electron (SE) picture at 20 kV (kiloVolt)) were made using a LEO-1530 Gemini electron microscope The samples were gold coated by vacuum vapour deposition prior to analysis. SEM was used to study the morphology of the crystals and the homogeneity of the samples.

### Reference Example 1.3: (ATR) IR Spectrum

The (ATR) IR spectra were collected using a Nicolet 6700 FT-IR spectrometer. ATR-FTIR spectra were taken between 400 and 4000 cm⁻¹ with a resolution of 4 cm⁻¹ from a sample using a Smart Orbit Diamond ATR unit.

### Reference Example 1.4: ²⁹Si MAS NMR spectrum

The ²³Si MAS NMR spectra were recorded at around 23° C. with a Bruker ASX-400 spectrometer using standard Bruker MAS probes and operated at 79.493 MHz. In order to average the chemical shift anisotropies, samples were spun about the magic angle. Tetramethylsilane was used as a chemical shift reference.

Pulse width: 4*10⁻⁶ s, Recycle time: 60 s, Spinning rate: 4 kHz, No. of scans: 224.

### Reference Example 1.5: Thermoanalysis DTA and TG

The Thermoanalysis DTA and data TG were collected using simultaneous DTA/TG measurements using a Bahr STA-503 thermal analyser. The sample was heated in synthetic air from 30 to 1000° C. with a heating rate of 10 K/min.

### Example 1: Protocol for Preparation of the Layered Silicate According to the Invention

| | |
|---|---|
| Silica gel (11 weight-% H₂O; | 1.12 g |
| synthesized as described below): | |
| Diethyldimethylammonium hydroxide | 6.00 g |
| (aqueous solution, 20 weight-%) | |

### i) Preparation of the Silica Gel (11 Weight-% H₂O)

Solution A: 235.9 ml tetraethylorthosilicate (Sigma) were mixed with 363.9 ml ethanol. Solution B: 0.09 g NH₄F (95% weight-%, Merck) were dissolved in 36 ml H₂O. Subsequently Solution B was dropwise added to solution A at around 23° C. This mixture was kept under static conditions at around 23° C. for 24 hours, providing a hydrous gel which was further heated at 70° C. for 3 d, then at 110° C. for 1 d and finally heated at 500° C. for 5 d. The resulting silica gel (a wet-process silica) was milled by hand in a mortar and then kept in an open beaker. The silica gel was characterized by powder XRD according to reference example 1.1, DTA/TG according to reference example 1.5 and ²³Si MAS NMR according to reference example 1.4. The powder XRD pattern showed only a very broad peak centered at 23° 2-theta. The ²³Si MAS NMR showed 3 signals at ca. −92.0 ppm (Q²-type), −102.3 ppm (Q³-type), 110.1 ppm (Q⁴-type) with approx. intensity ratios of 15%:70%:15%, respectively. TG showed a total weight loss (loss of H₂O) of 11% occurring in two steps: a) between around 23° C. and 150° C. (9%) and b) in the range of 200° C. to 800° C. (2%).

### ii) Preparation of the Layered Silicate According to the Invention

1.12 g of the silica gel (11 weight-% H₂O) prepared in i) were added to 6.00 g of the diethyldimethylammonium hydroxide solution. This mixture was stirred at around 23° C. for a time (T₁—see Table 1 below). Subsequently, the mixture was heated in a vacuum oven at 70° C. and 20 mbar for a time (T₂—see Table 1 below). During this treatment, an amount of water (A₁—see Table 1 below) was removed from the mixture. The resulting mixture was then filled into a Teflon-lined steel autoclave, the autoclave sealed, then the autoclave was heated under static conditions to a temperature of at (X₁—see Table 1 below) and kept at this temperature for a time (T₃—see Table 1 below). After pressure release and cooling to around 23° C., the product was thoroughly washed with distilled water, until the washing water had a conductivity of less than 200 microSiemens. The thus obtained washed product (RUB-56) was then separated by centrifugation and dried in air at around 23° C. overnight. The composition of the inventive material per unit cell according to the crystal structure analysis was determined in view of the XRD data, said data being obtained as described in Reference Example 1.1. The composition of the inventive material per unit cell is as follows:

(C₆H₁₆N)₈[Si₃₂O₆₄(OH)₈]*24H₂O

The XRD pattern, determined as described in Reference Example 1.1, is shown in FIG. 1. The structure was solved by comparison with the XRD powder data of ITQ-8 and by comparison with the FTIR spectrum of ITQ-8. The structure of RUB-56 was refined using the FullProf 2K program. The SEM picture, determined as described in Reference Example 1.3, is shown in FIG. 2. The (ATR) IR Spectrum, determined as described in Reference Example 1.4, is shown in FIG. 3. The ²⁹Si MAS NMR spectrum, determined as described in Reference Example 1.5, is shown in FIG. 4. The thermoanalysis DTA and TG, determined as described in Reference Example 1.6, is shown in FIG. 5.

### Comparative Examples 1 to 5: Protocol for the Comparative Examples

For comparative examples 1 to 5, a similar protocol was employed based on that used for the inventive example, with the following modifications as summarized in Table 1. Unless otherwise indicated in Table 1, the same materials and amounts thereof were used as per (inventive) Example 1.

TABLE 1
Summary of the Inventive and the Comparative Examples

| | | | | |
|---|---|---|---|---|
| | Step | Step (i.2) | | |
| | (i.1, | time/ | (iii) hydrothermal | Molar Composition |
| Silica-gel | mixing | amount | synthesis conditions | of synthesis mixture |
| (11% | time) | H₂O lost | Temp/time | obtained from |
| H₂O) | (T₁) | (T₂)/(A₁) | (X₁)/(T₃) | step (i.2) |

Inventive Example

| | | | | | |
|---|---|---|---|---|---|
| Example 1 | 1.12 g | 30 min | 80 min/ | 140° C./ | 0.9 SiO₂: |
| (RUB-56) | | | 2.4 g | 48 h | 0.5 DEDMA-OH: |
| | | | | | 6.7 H₂O |

Comparative Examples

| | | | | | |
|---|---|---|---|---|---|
| Comparative | 1.12 g | 60 min | 45 min/ | 120° C./ | 1.0 SiO₂: |
| Example 1 | | | 1.1 g | 2 days | 0.5 DEDMA-OH: |
| (amorphous) | | | | | 10 H₂O |
| Comparative | 1.36 g | (ca. 10 | 50 min/ | 160° C./ | 1.0 SiO₂: |
| Example 2 | | min) | 1.3 g | 7 days | 0.5 DEDMA-OH: |
| (RUB-36) | | (until | | | 9.7 H₂O |
| | | uniform gel | | | |
| | | formed) | | | |
| Comparative | 1.36 g | (ca. 10 | 50 min/ | 150° C./ | 1.0 SiO₂: |
| Example 3 | | min) | 1.3 g | 11 days | 0.5 DEDMA-OH: |
| (RUB-36) | | (until | | | 9.7 H₂O |
| | | uniform gel | | | |
| | | formed) | | | |
| Comparative | 1.12 g | 30 min | 45 min/ | 130° C./ | 1.0 SiO₂: |
| Example 4 | | | 1.1 g | 7 days | 0.5 DEDMA-OH: |
| (RUB-52) | | | | | 10 H₂O |
| Comparative | 1.12 g | ca. 2 | 40 min/ | 140° C./ | 1.0 SiO₂: |
| Example 5 | | minutes | 1.15 g | 7 days | 0.5 DEDMA-OH: |
| (RUB-52) | | | | | 10 H₂O |

As can readily be seen from Table 1, Comparative Example 1 demonstrates that when low synthesis temperatures are used for the hydrothermal synthesis conditions, then an amorphous material is obtained. Furthermore, from Table 1 it can be seen that RUB-36 forms at higher hydrothermal synthesis temperatures. Finally, when prolonged hydrothermal synthesis conditions were employed a different product, denoted as RUB-52, was obtained.

### BRIEF DESCRIPTION OF THE FIGURES

FIG. 1: shows the XRD pattern of RUB-56 according to Example 1. On the y axis, the intensity (arbitrary units) is shown.

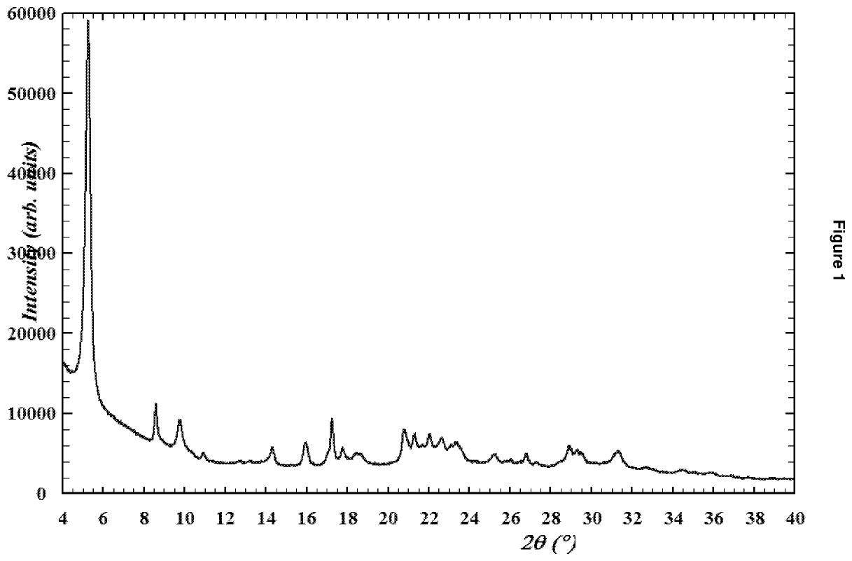

FIG. 2: shows the SEM picture of RUB-56 according to Example 1.

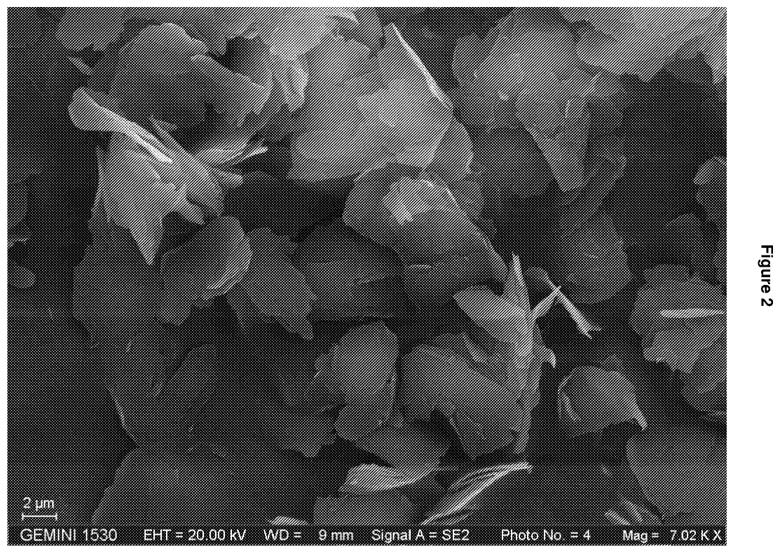

FIG. 3: shows the (ATR) IR Spectrum of RUB-56 according to Example 1.

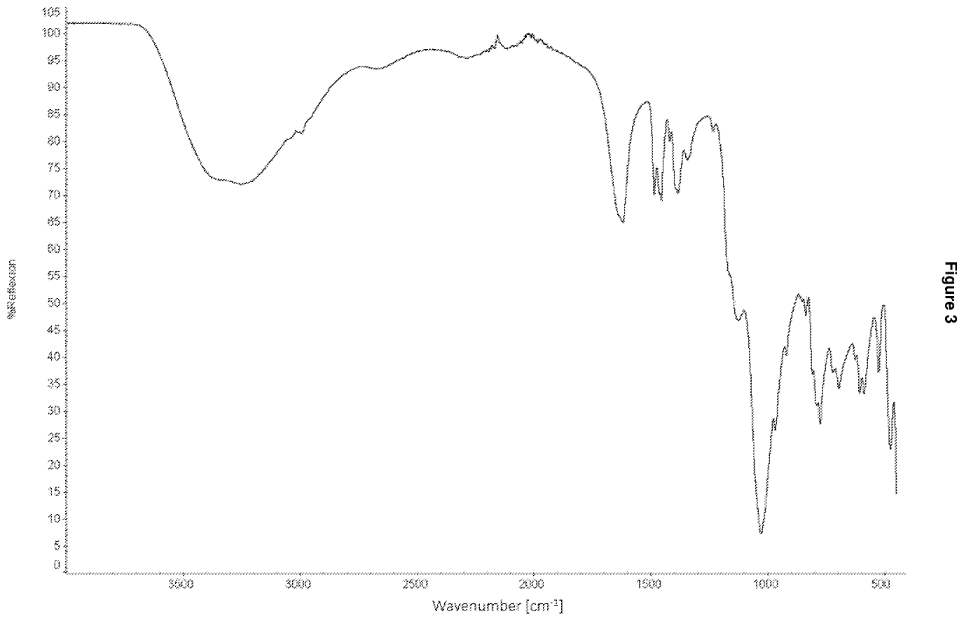

FIG. 4: shows the ²⁹Si MAS NMR spectrum of RUB-56 according to Example 1, comprising Q³-type (−99 ppm and −101 ppm) and Q⁴-type (−106 and −108 ppm) signals.

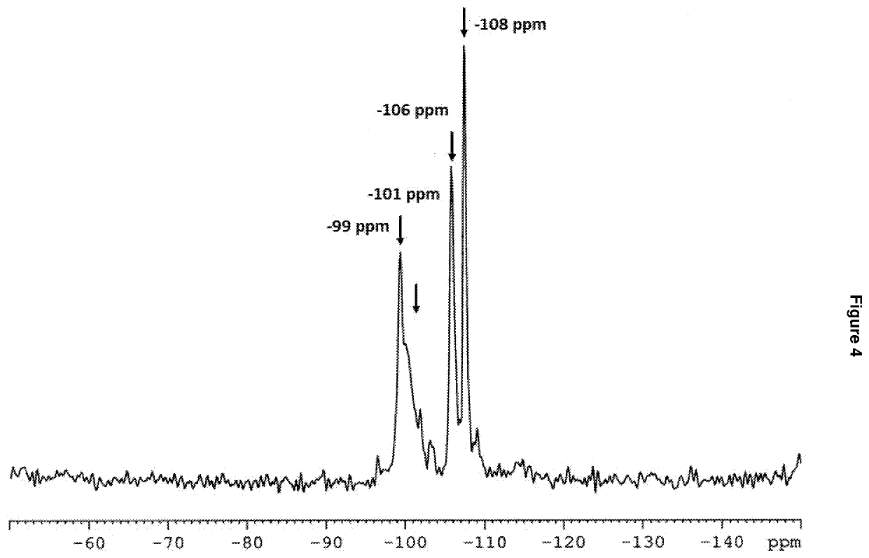

FIG. 5: shows the thermoanalysis DTA and TG of RUB-56 according to Example 1.

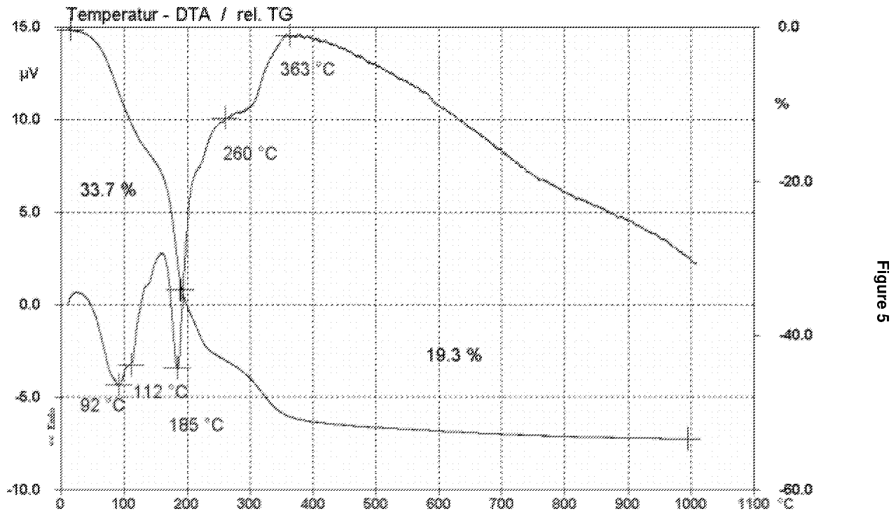

FIG. 6: shows a schematic representation of the structure of RUB-56.

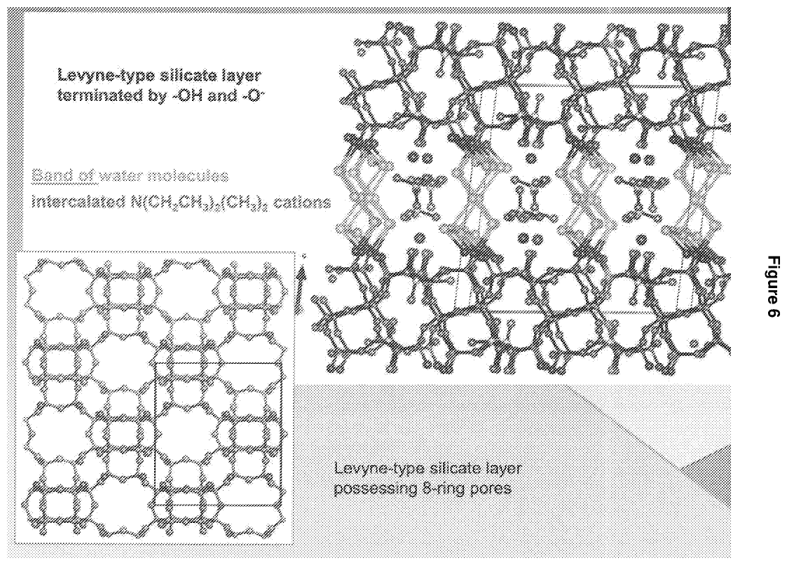

FIG. 7: shows the XRD pattern of the amorphous material according to Comparative Example 1.

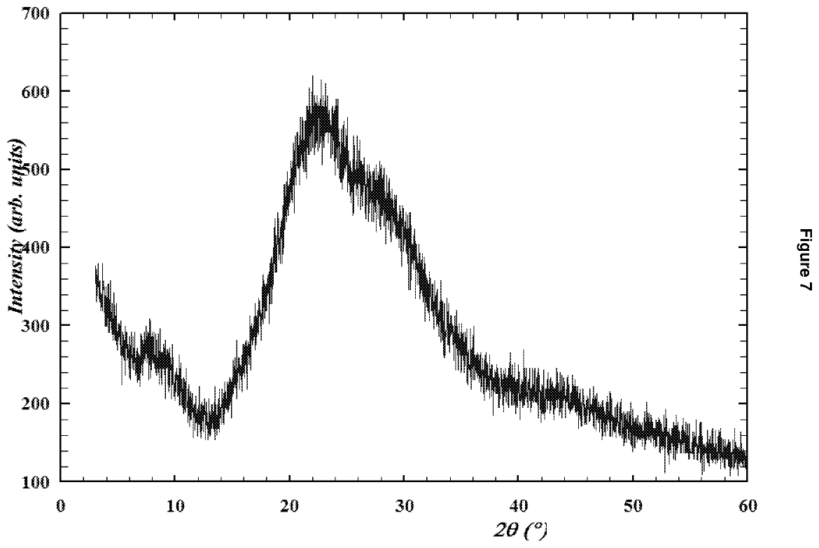

FIG. 8: shows the XRD pattern of RUB-36 according to Comparative Example 2.

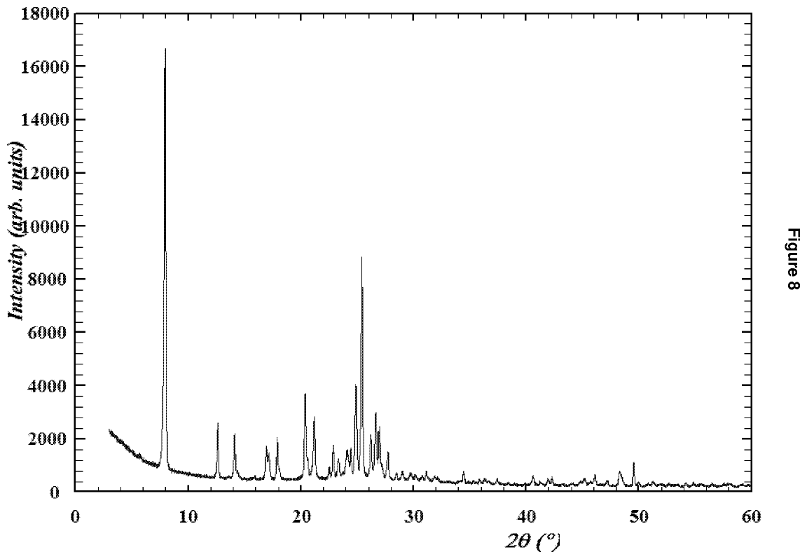

FIG. 9: shows the XRD pattern of RUB-36 according to Comparative Example 3, containing ca. 2% RUB-52 as an impurity (Peak at 5.8° 2-theta in the XRD pattern).

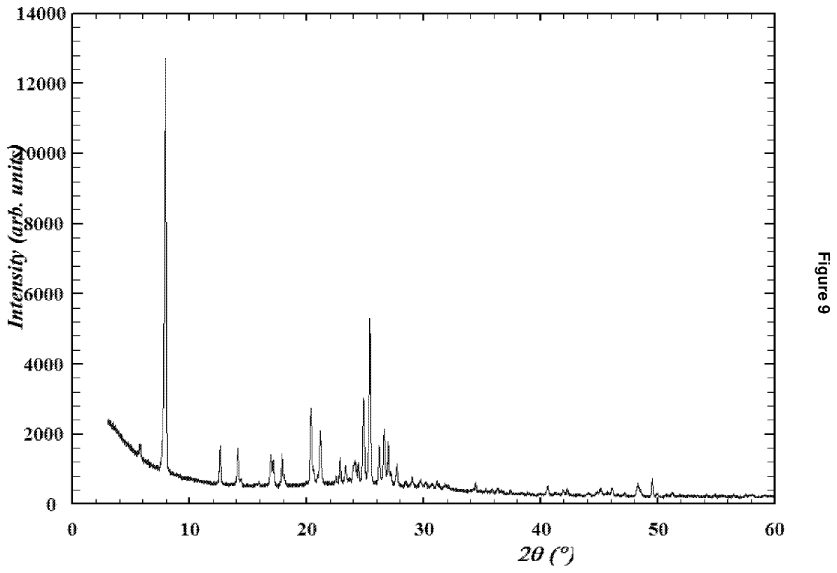

FIG. 10: shows the XRD pattern of RUB-52 according to Comparative Example 4.

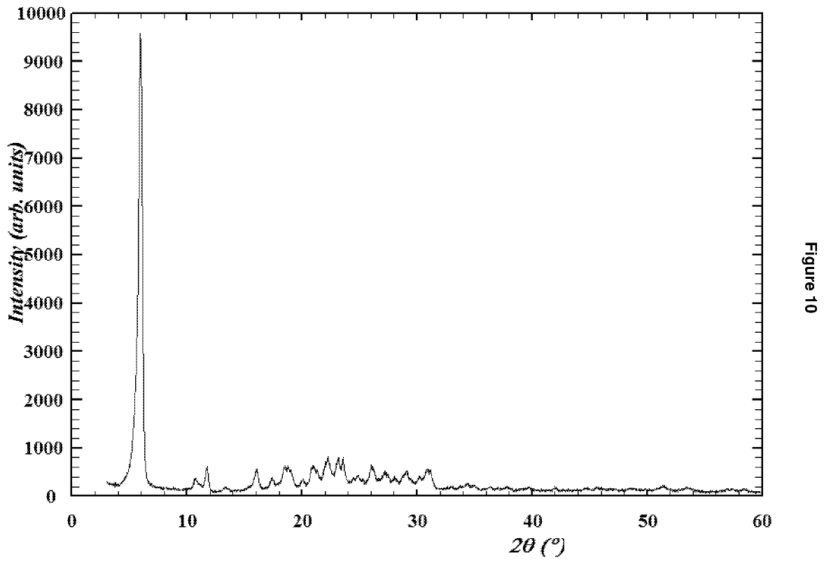

FIG. 11: shows the XRD pattern of RUB-52 according to Comparative Example 5.

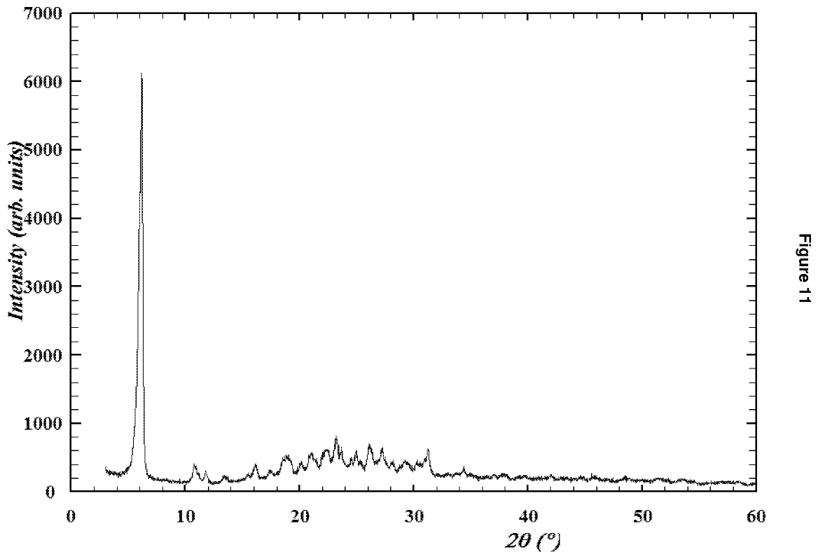

### CITED LITERATURE

Bernd Marler, Melanie Müller, Hermann Gies: Structure and Properties of ITQ-8: A Hydrous Layer Silicate with Microporous Silicate Layers, Dalton Transactions 45, pages 10155-10164 (2016)
Bernd Marler, H. Gies: Hydrous layer silicates as precursors for zeolites obtained through topotactic condensation: a review. Eur. J. Mineral, 24, pages 405-428 (2012)

1. A crystalline layered silicate, having an X-ray diffraction pattern, when measured at a temperature in a range of from 15 to 25° C. with CuKalpha_{1,2} radiation having a wavelength of 0.15419 nm, comprising reflections at 2-theta values of:
5.3±0.2°;
8.6±0.2°;
9.8±0.2°;
21.7±0.2°, and
22.7±0.2°.

2. The silicate of claim 1, having:
an IR spectrum comprising twelve peaks with maxima at 475±5 cm⁻¹, 526±5 cm⁻¹, 587±5 cm⁻¹, 609±5 cm⁻¹, 628±5 cm⁻¹, 698±5 cm⁻¹, 724±5 cm⁻¹, 776±5 cm⁻¹, 587±5 cm⁻¹, 794±5 cm⁻¹, 809±5 cm⁻¹, and 837±5 cm⁻¹.

3. The silicate of claim 1, wherein from 95 to 100 wt. % of the layered silicate consists of Si, O, C, N, and H.

4. The silicate of claim 1, having a unit cell of formula (I):
(C₆H₁₆N)₈[Si₃₂O₆₄(OH)₈]*xH₂O (I),
wherein x is in a range of from 8 to 30.

5. A process for preparing a crystalline layered silicate the process comprising:
(i) preparing a synthesis mixture comprising water, a source of Si, and a structure directing agent comprising a diethyldimethylammonium compound;
(ii) subjecting the synthesis mixture, comprising water, a source of Si, and a structure directing agent comprising a diethyldimethylammonium compound, to hydrothermal synthesis conditions comprising heating the synthesis mixture to a temperature in a range of from 110 to 180° C. and keeping the synthesis mixture at a temperature in this range under autogenous pressure for 1 to 6 days, to obtain a mother liquor comprising the crystalline layered silicate.

6. The process of claim 5, wherein the source of the Si comprises a wet-process silica, a dry-process silica, and/or a colloidal silica.

7. The process of claim 5, wherein, in the synthesis mixture, a molar ratio of the structure directing agent relative to the source of Si, calculated as SiO₂, defined as SDA:SiO₂, is in a range of from 0.3:1 to 2:1.

8. The process of claim 5, wherein from 95 to 100 wt. % of the synthesis mixture consists of water, the source of Si, and the structure directing agent comprising a diethyldimethylammonium compound.

9. The process of claim 5, wherein the synthesis mixture is prepared by a process comprising
(i.1) preparing a mixture comprising water, the source of Si, and the structure directing agent comprising a diethyldimethylammonium compound at a temperature of the mixture in a range of from 10 to 40° C.;
(i.2) heating the mixture to a temperature in a range of from 50 to 120° C. and keeping the mixture at a temperature in this range, to obtain the synthesis mixture.

10. The process of claim 9, wherein the heating (i.2) comprises heating the mixture to a temperature in a range of from 50 to 100° C.

11. The process of claim 9, wherein in the synthesis mixture, a molar ratio of water relative to the source of Si, calculated as SiO₂, defined as the H₂O:SiO₂, is in a range of from 4:1 to 15:1.

12. The process of claim 5, wherein, in the subjecting (ii), the synthesis mixture is heated to a temperature in a range of from 120 to 170° C.

13. The process of claim 5, further comprising
(iii) optionally cooling the mother liquor obtained from the subjecting (ii);
(iv) separating the crystalline layered silicate from the mother liquor.

14. A layered silicate, obtained by the process of claim 5.

15. A catalytically active material, catalyst, intermediate suitable for preparing a catalyst, or catalyst component, comprising the silicate of claim 1.

16. The silicate of claim 1, having a ²⁹Si MAS NMR spectrum comprising Q³-type signals at −99±2 ppm and −101±2 ppm and Q⁴-type signals at −106±2 ppm and −108±2 ppm.

17. The silicate of claim 2, having a ²⁹Si MAS NMR spectrum comprising Q³-type signals at −99±2 ppm and −101±2 ppm and Q⁴-type signals at −106±2 ppm and −108±2 ppm.

18. The silicate of claim 2, having an IR spectrum further comprising peaks with maxima at 1397±5 cm⁻¹, 1421±5 cm⁻¹, 1457±5 cm⁻¹, 1464±5 cm⁻¹, and 1487±5 cm⁻¹.

19. The silicate of claim 1, wherein from 98 to 100 wt. % of the layered silicate consists of Si, O, C, N, and H.

20. The silicate of claim 1, wherein from 99 to 100 wt. % of the layered silicate consists of Si, O, C, N, and H.
